(19) United States
(12) Patent Application Publication
(10) Pub. No.: US 2010/0262526 A1
(43) Pub. Date: Oct. 14, 2010

(54) Method of Goal Analysis

(75) Inventor: Malcolm Nigel Johnson, Samford (AU)

Correspondence Address: SHOEMAKER AND MATTARE, LTD, 10 POST OFFICE ROAD - SUITE 100, SILVER SPRING, MD, 20910, US

(73) Assignee: SALIENT LIFE HOLDINGS PTY LTD, Samford (AU)

(21) Appl. No.: 12/757,534

(22) Filed: Apr. 9, 2010

(30) Foreign Application Priority Data
Apr. 9, 2009 (AU) 2009901536

(51) Int. Cl. G06Q 40/00; G06Q 99/00; G06F 15/16

(52) U.S. Cl. 705/35; 705/1.1; 709/227

(57) ABSTRACT

The present invention relates to a computer-implemented method of analyzing a person's goals in light of their motivations and aspirations for the purposes of identifying relevant financial goals for the person. This is achieved by a person answering questions to provide data and processing the data in a statistically meaningful manner to identify actions and activities that support the achievement of the relevant financial goals. From the actions and activities, a financial plan can be formed setting out when, where, what and who will carry out the actions to progress the financial goals.

### FIELD OF INVENTION

The present invention relates to a method for analyzing a person's goals and objectives. The present invention has particular but not exclusive application for the analysis and setting of financial goals and objectives. Reference in the body of the specification to the application of the method to analyze and set personal financial goals and objectives is by way of example only and the method is not limited to this particular application.

### BACKGROUND OF THE INVENTION

In preparing a financial plan for a client, financial planners are required by the Australian Security and Investment Commission (ASIC) to know the goals and needs of the client. At present, financial planners ask a series of questions designed to elicit personal details from the client. Typically these questions comprise “why are you seeking financial advice?”, “what are your immediate financial objectives within the next twelve months?”, “what financial objectives do you wish to obtain within the next 5 or 10 years?” and “when do wish to retire?”. The answers to these questions are recorded in the interview for the financial planner to provide a qualitative assessment of their client's goals.

In practice the answers provided by the client relies on their ability to articulate their goals. Clients rarely have considered their goals and objectives and how to achieve them to any detailed extent. Beyond superficial goals, many people find it difficult to provide any depth or integration that will assist a financial planner to confidently rely on such a goal statement for the purpose of preparing a financial plan. In part, these superficial responses may also be due to the financial planner's inexperience in conducting depth interviews to obtain meaningful results. Financial planners are not trained in research techniques that help them to conduct these types of interviews and in what questions to ask and how to ask them. Currently there is no adequate way that a financial planner can obtain a meaningful understanding of their client's goals and objectives.

### OBJECT OF THE INVENTION

It is an object of the present invention to provide a method of analyzing a person's goals and objectives that overcomes at least in part one or more of the abovementioned problems.

### SUMMARY OF THE INVENTION

The current invention was developed from the realization that any meaningful and relevant financial plan will be prepared in light of a client's goals and objectives, the importance of each of these to the client and when the client wishes to achieve the goals and objectives. The current invention involves taking into consideration various aspects of a person's life, their goals and objectives, and their motivations in order to make relevant financial decisions. The present invention comprises collecting data, shaping the data in a common format and processing the formatted data to produce a result. There is a further optional step of setting out strategies to achieve the determined result in a set time frame. A breakthrough in the present invention is the collecting of personal data and processing the collected data in a common format so that a meaningful result can be determined. In other words, the present invention has been able to capture qualitative personal data and process it in a comparative quantitative manner to achieve a meaningful result.

In one aspect the present invention broadly resides in a computer-implemented method of analyzing a person's goals comprising: entering data from a terminal computer by the person to a program hosted on a server computer system; processing said data by the program to identify one or more core motivations relative to their importance , said core motivations comprise secure lifestyle, quality relationships, sense of accomplishment, being well respected, helping others and fun and enjoyment in life; to identify one or more life domains relative to their importance and the person's satisfaction with the life domain, said life domains comprise home, personal finance, work, personal growth, family life, social life, recreation and health; and to statistically analyze the contribution that each life domain provides to each of the relevant core motivations; processing said data to identify activities that progress each of the relevant life domains; and producing a relevant advice product from the processed data that sets out one or more actions selected from the activities to be carried out within a timeframe and being relevant to the person's goals wherein the performance of the one or more actions will progress the person's life satisfaction.

Preferably the relevant advice product is in the form of a printable document. Preferably the relevant advice product is presented in a linkage map or matrix mapping the person's life domains against their motivations and the person's life domains against the actions. Alternatively the relevant advice product is in the form of a report with description, tables and graphs.

Preferably the actions are set out for sequential performance. Actions primarily associated with less important life domains can be selected because they may have a positive effect on the more important life domains.

The entered data is preferably answers to questions displayed on the terminal computer from the user interface end of the program.

The data about the person's life activities and motivation for each life activity is analyzed to preferably provide a multidimensional representation or map that interrelates the person's priority motivation with a life activity in a prevailing life domain. The multidimensional representation is then used to identify the importance of each life activity to the person.

The data from multidimensional representation also enables the person's advisor to formulate objective questions that enable the advisor to understand the person's goals and objectives. With a more meaningful understanding of the person's goals and objectives, the advisor can perform a structured interview with the person and then construct a suitable plan for the person to achieve their goals and objectives.

With the multidimensional representation the person may take steps to achieve their goal or objective by performing the identified activities in the determined time frames. In a preferred embodiment the method comprises the further step of selecting the important activities within a particular time frame and preparing a strategy of activities to achieve the activities within the time frame.

The method preferably provides a hierarchal structure for goal analysis where motivations provide higher order goals that guide behaviour and motivate a person in a particular life domain to perform a relevant activity within the desired time frame.

In a second aspect, the invention broadly resides in a computer program product having stored thereon computer executable instructions, which when executed, causes the computer to perform the method as defined above.

In a third aspect, the invention broadly resides in a web-based computer program product having stored thereon computer executable instructions, which when executed on a web-based computer system causes the web-based computer system to perform the method as defined above.

In a fourth aspect the invention broadly resides in a computer system for notifying a person of relevant actions to be carried out to enhance their level of life satisfaction, the computer system comprising:

a processor, memory interfaced with the processor, and a network interface for establishing a network connection over a data communication network with a terminal computer;

a module for detecting at least one activity occurring at a terminal computer that is activated for displaying or requesting information to elicit data from the person,

a module for processing the data from the person to identify one or more core motivations relative to their importance, said core motivations comprise secure lifestyle, quality relationships, sense of accomplishment, being well respected, helping others and fun and enjoyment in life; to identify one or more life domains relative to their importance and the person's satisfaction with the life domain, said life domains comprise home, personal finance, work, personal growth, family life, social life, recreation and health; and to statistically analyze the contribution that each life domain provides to each of the relevant life domains; and processing said data to identify activities that progress each of the relevant core motivations;

a module to display or provide a relevant advice product comprising one or more actions relevant to progressing the person's life satisfaction.

The computer system preferably comprises a plurality of further modules that are configured for performing any one or more of the method steps as herein defined, described and illustrated.

In a fifth aspect the present invention broadly resides in a computer-implemented method to identify a person's financial goals with reference to their life goals and motivations, comprising

entering data from a terminal computer by the person to a program hosted on a server computer system;

processing said data by the program to identify one or more core motivations relative to their importance, said core motivations comprise secure lifestyle, quality relationships, sense of accomplishment, being well respected, helping others and fun and enjoyment in life; to identify one or more life domains relative to their importance and the person's satisfaction with the life domain, said life domains comprise home, personal finance, work, personal growth, family life, social life, recreation and health; and to statistically analyze the contribution that each life domain provides to each of the relevant core motivations;

processing said data to identify activities that progress each of the relevant life domains; and

producing a relevant financial advice product from the processed data that sets out one or more actions selected from the activities to be carried out within a timeframe and being aligned with the person's life goals and motivations, wherein the performance of the one or more actions will contribute to achieving the person's financial goals.

From the relevant financial advice product, a financial plan is preferably prepared setting out a timed strategy for carrying out the identified one or more actions that are relevant to achieving the person's financial goals. The financial plan preferable sets out the tasks and resources needed to carry out each of the actions. The further information regarding tasks and resources is preferably provided through discussions between a financial advisor and the person. The financial advisor can ask questions to initiate discussions. For example the financial advisor can ask: “Who will be responsible for making it happen?” “What skills will be required?” “What resources will be required?” “How much time will it take?”

With information about how, what, when and who, the financial advisor can preferably plan an effect strategy for the person to achieve their financial goals in a specified time frame.

In a sixth aspect the present invention broadly resides in a computer-implemented method to identify a person's financial goals with reference to their life goals and motivations and provide a relevant financial plan for the person, comprising

entering data from a terminal computer by the person to a program hosted on a server computer system;

processing said data by the program to identify one or more core motivations relative to their importance, said core motivations comprise secure lifestyle, quality relationships, sense of accomplishment, being well respected, helping others and fun and enjoyment in life; to identify one or more life domains relative to their importance and the person's satisfaction with the life domain, said life domains comprise home, personal finance, work, personal growth, family life, social life, recreation and health; and to statistically analyze the contribution that each life domain provides to each of the relevant core motivations;

processing said data to identify activities that progress each of the relevant life domains;

producing a relevant financial advice product from the processed data that sets out one or more actions selected from the activities to be carried out within a timeframe and being aligned with the person's life goals and motivations, wherein the performance of the one or more actions will contribute to achieving the person's financial goals;

prepare a financial plan based on the identified one or more actions and determining what tasks are needed, who is responsible for carrying out the tasks, when are the tasks to be carried out and what is needed to carry out the tasks.

The financial plan can be prepared in consultation with a qualified financial advisor.

The financial plan is preferably a timed strategy for carrying out the relevant actions.

Features described in the other aspects of the invention also apply to the fifth and sixth aspects.

In a seventh aspect, the present invention broadly resides in a method for a financial adviser to provide financial advice and a financial plan for a person, comprising the steps of:

using the computer-implemented method of goal analysis as described above; and

preparing a financial plan based on the one or more actions identified from the computer-implemented method of goal analysis and determining what tasks are needed, who is responsible for carrying out the tasks, when are the tasks to be carried out and what is needed to carry out the tasks; said financial plan sets out a strategy and time frame when the actions are to be achieved.

### BRIEF DESCRIPTION OF THE DIAGRAM

In order that the present invention can be more readily understood and put into practical effect, reference will now be made to the accompanying drawing wherein:

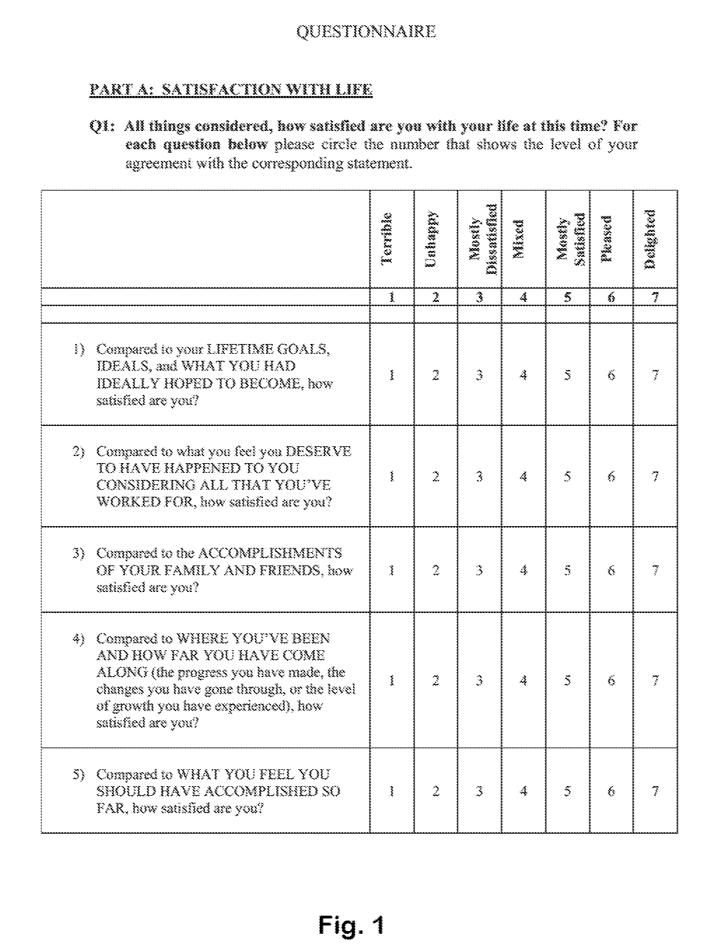

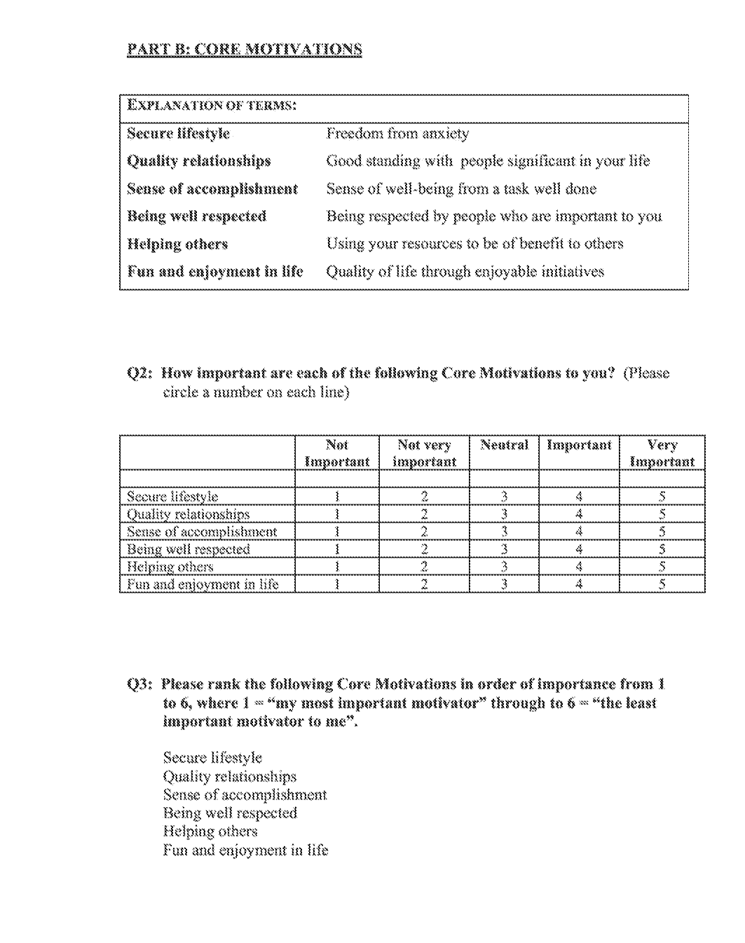

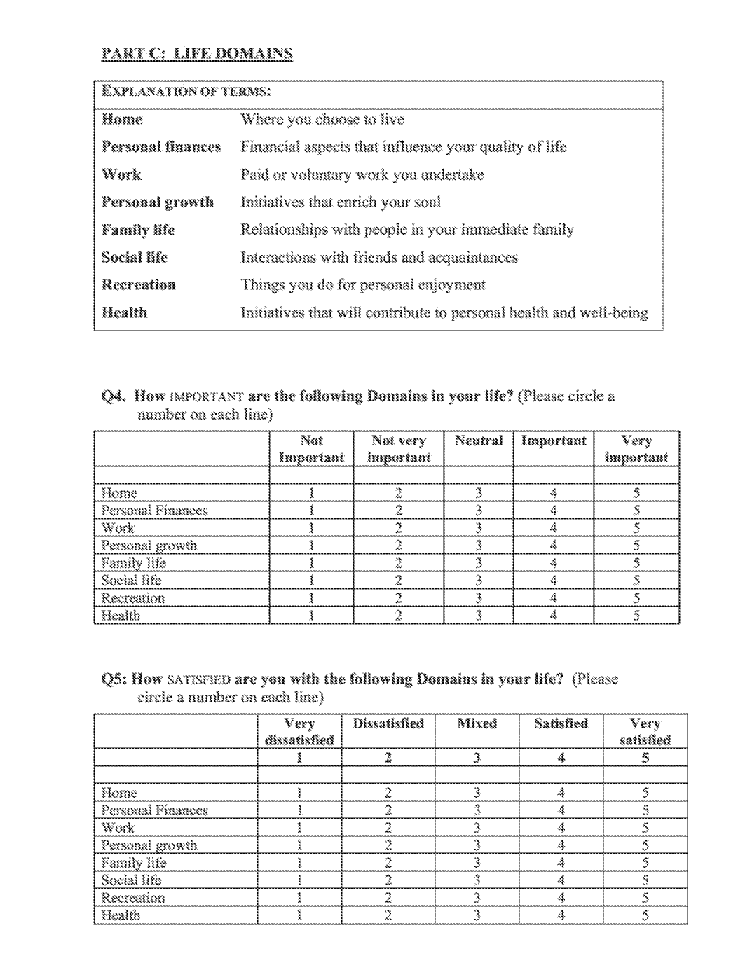

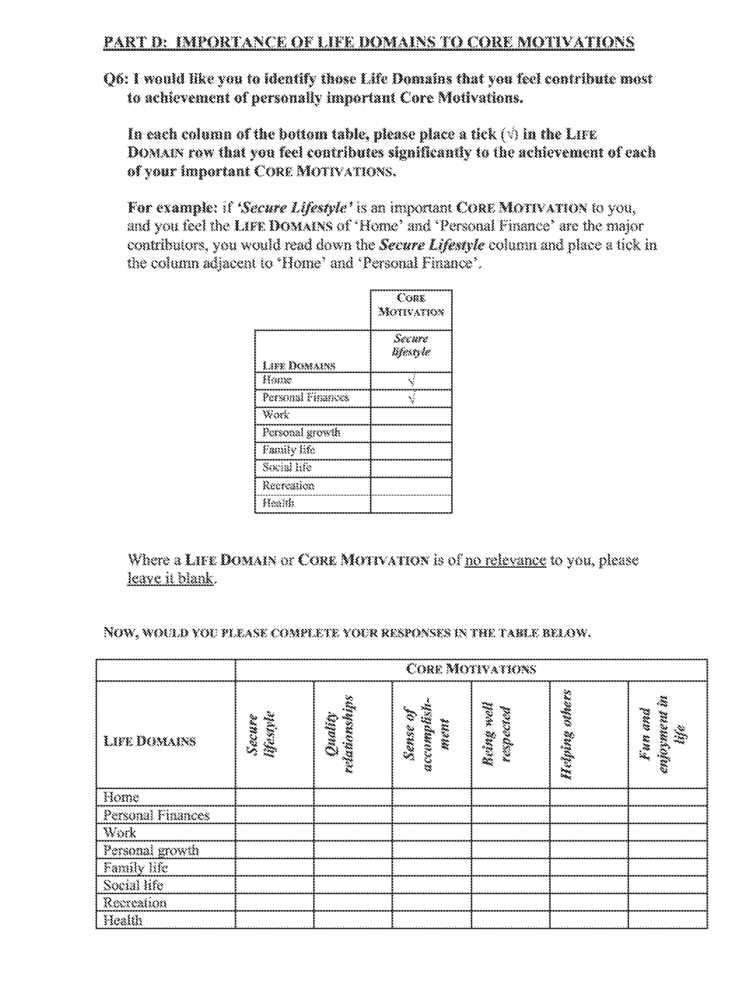

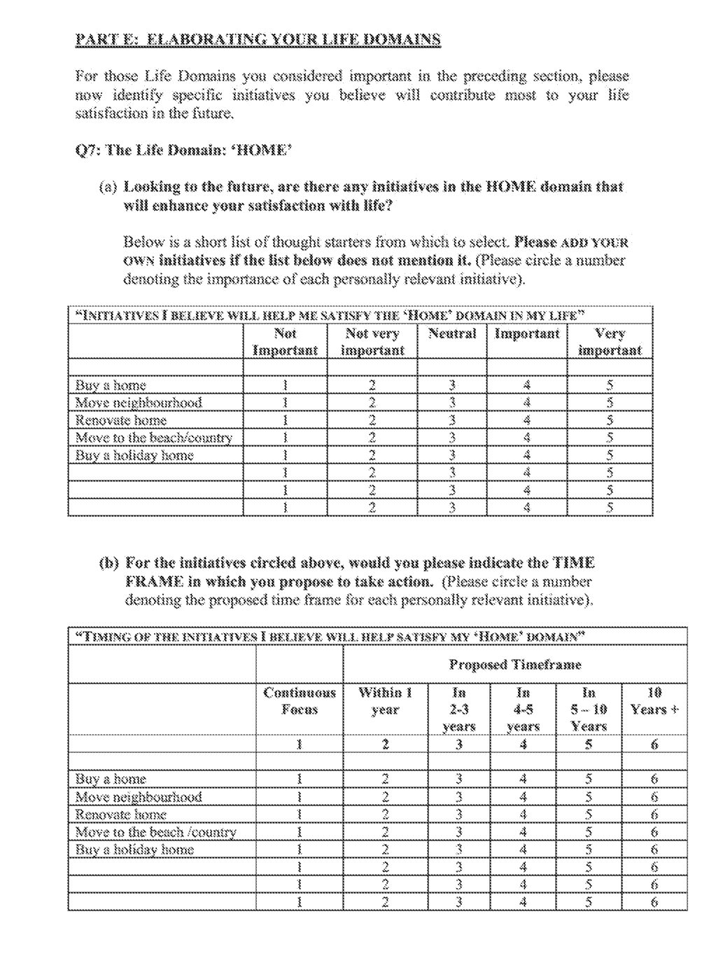

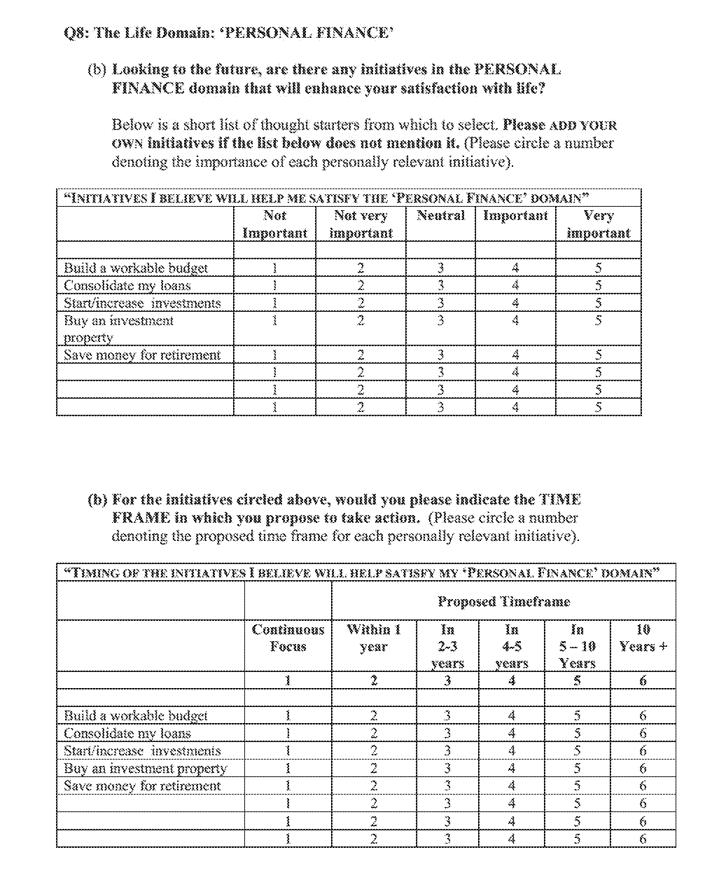

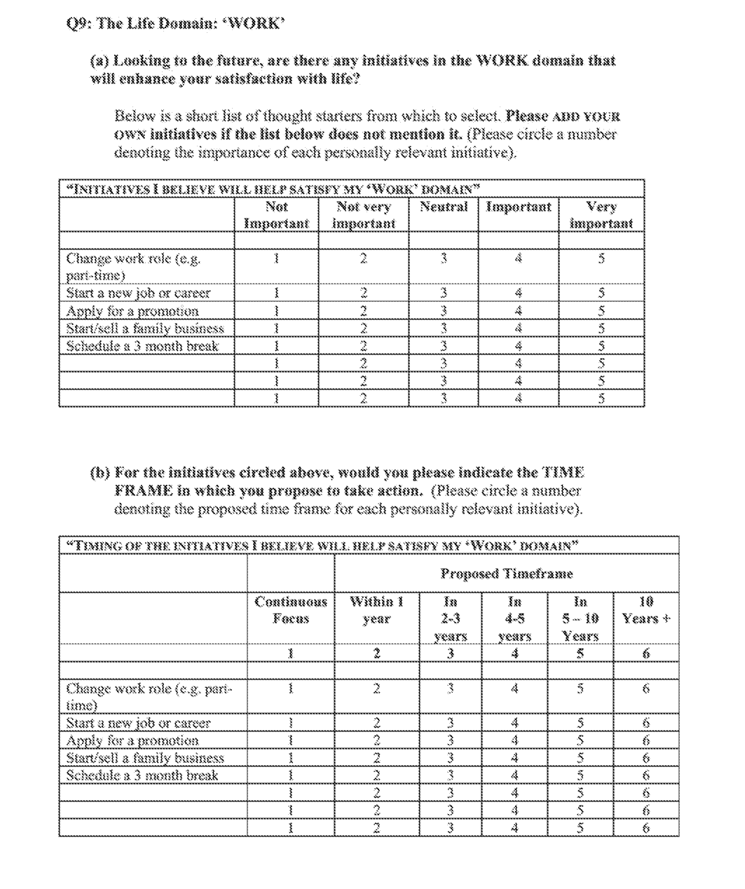

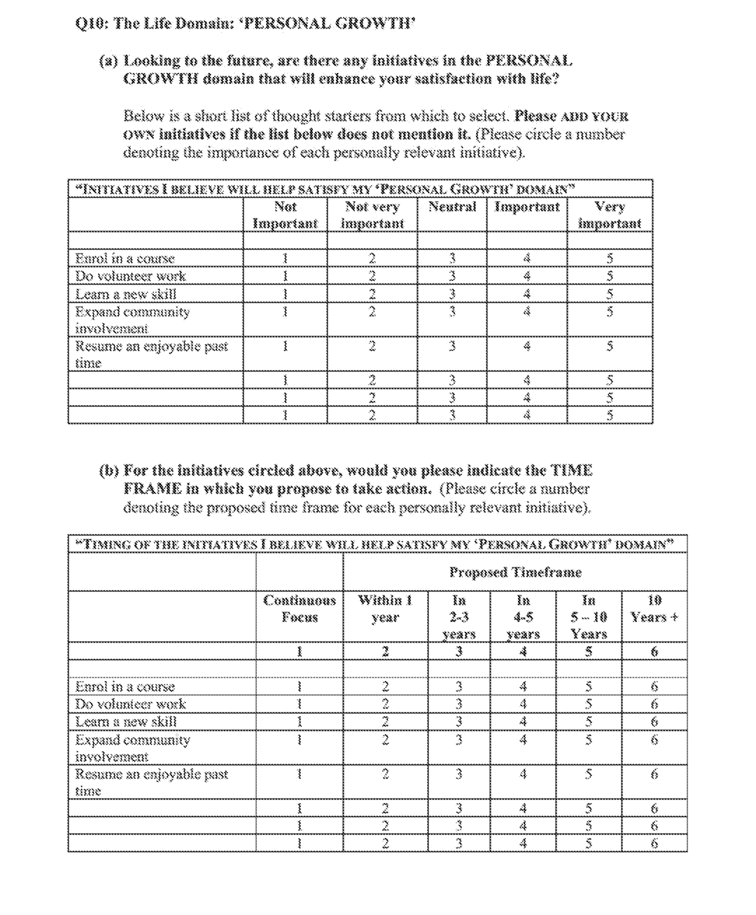

FIG. 1 is a sample questionnaire; and

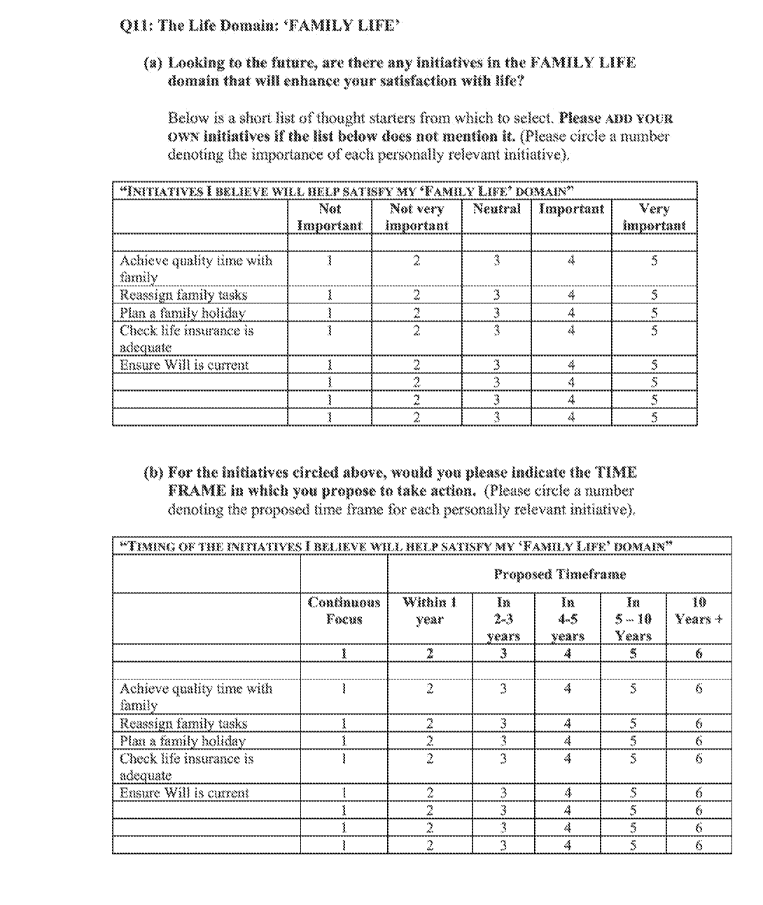

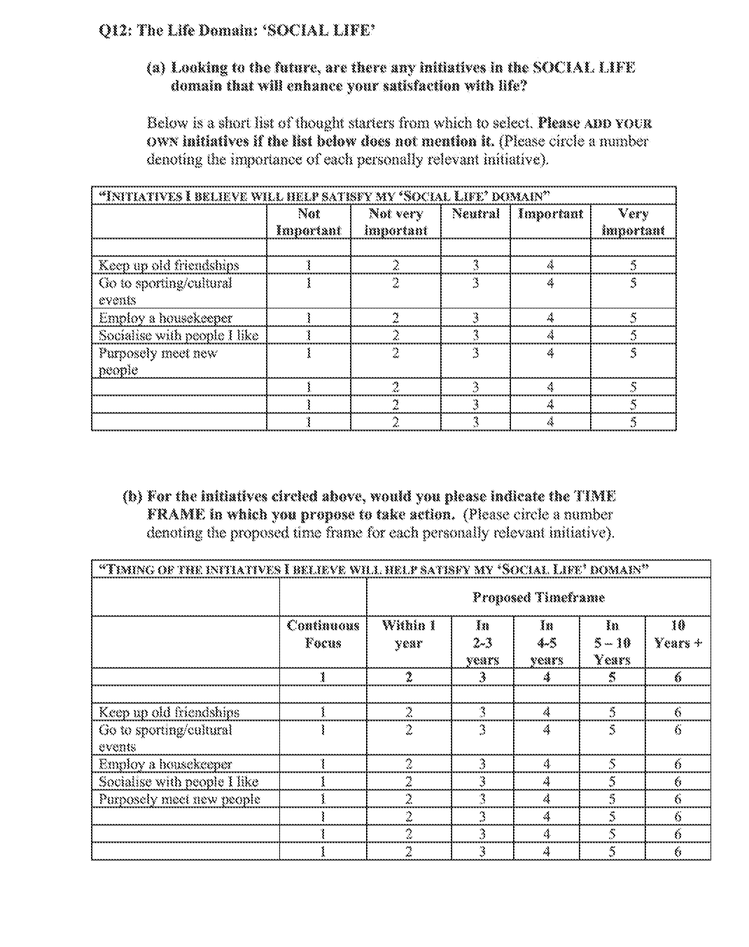

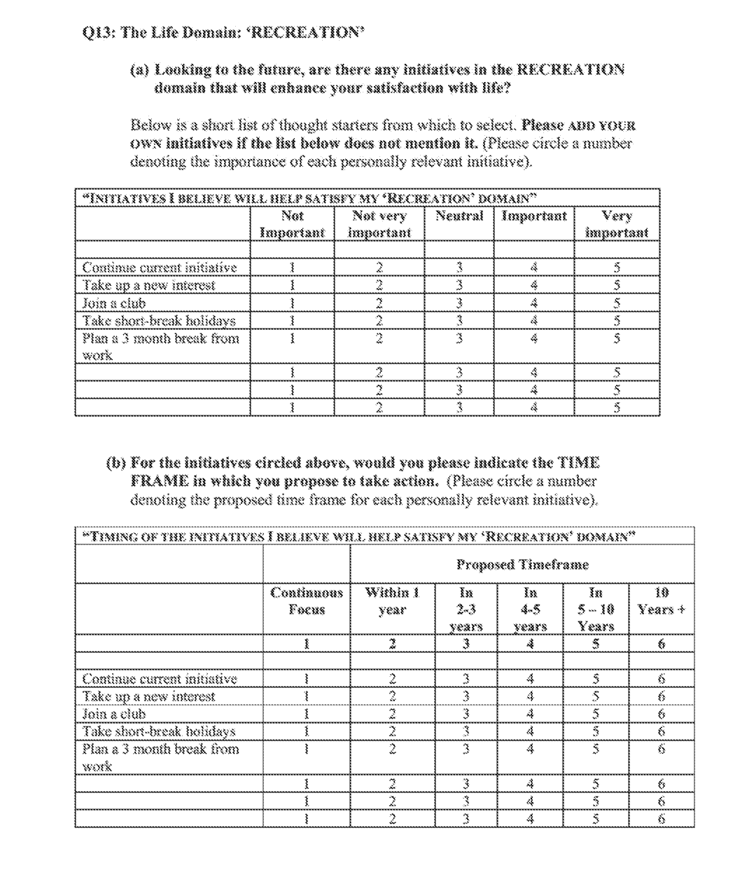

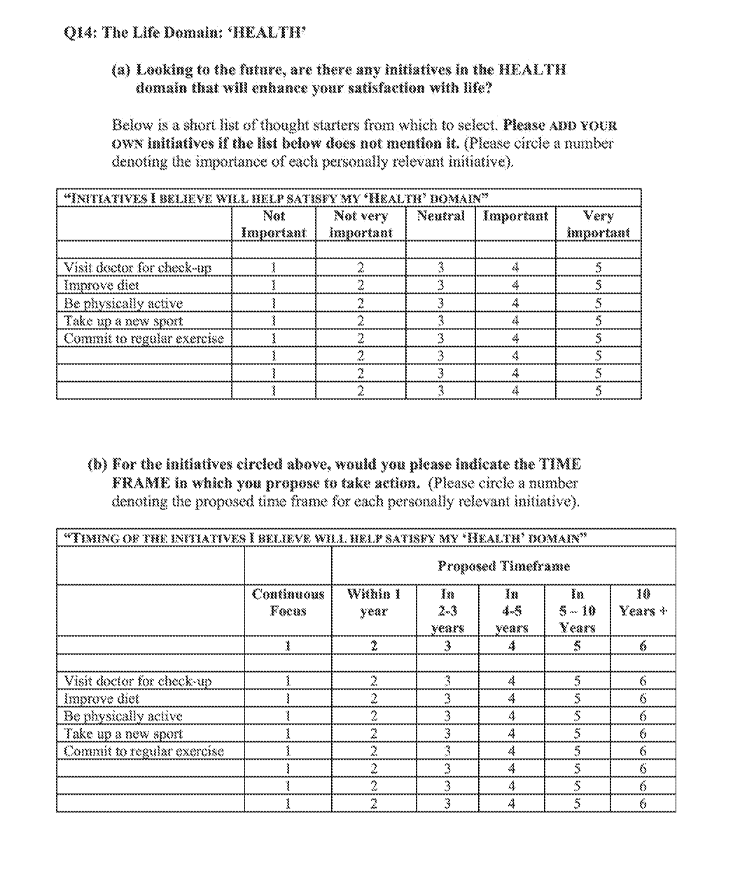

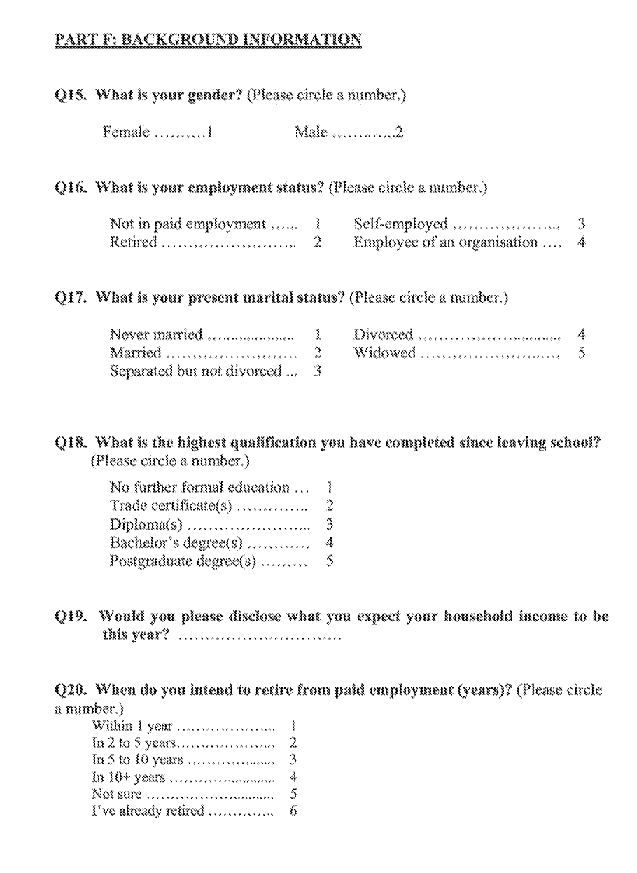

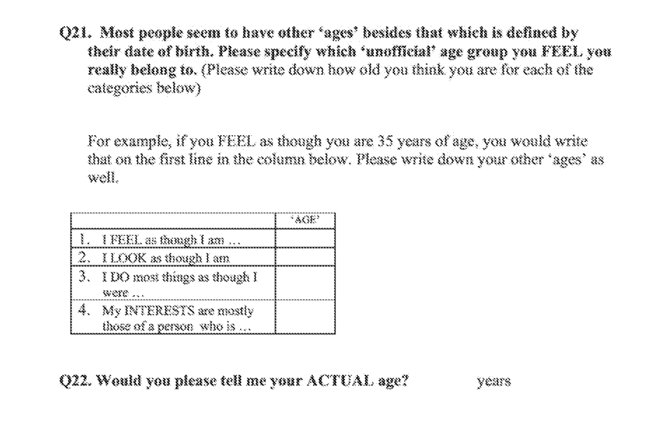

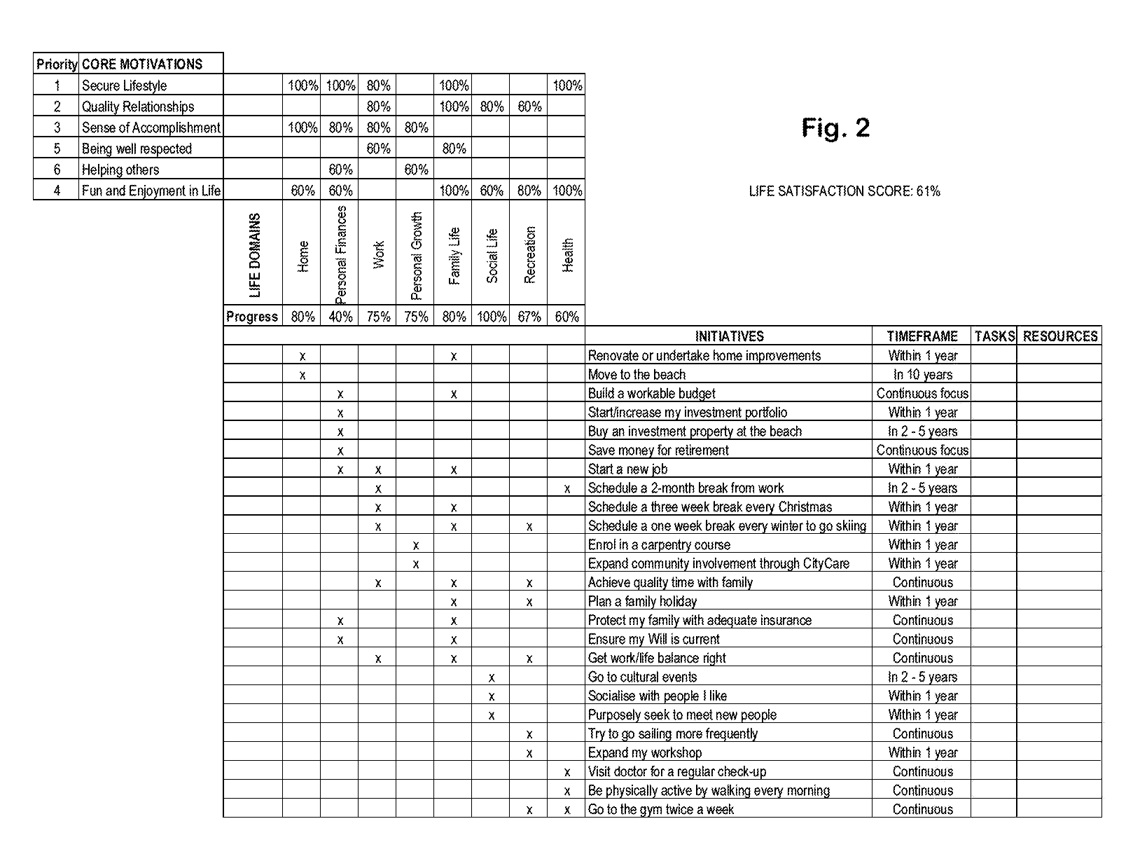

FIG. 2 is a linkage goal map or cumulative matrix for a person who has answered the questionnaire and their answers have been processed by a program coded on a remote processor. Further details of tasks and resources need to be determined before the actions can be carried out.

### DETAILED DESCRIPTION OF THE PREFERRED EMBODIMENT

The preferred embodiment of the method of the present invention is illustrated by application to financial planning where an adviser provides a series of questions, receives client answers to the questions, uses the answers as data to determine a client's motivations or aspirations, goals and objectives in life, and using these determinations as a basis to make a specific financial plan with action steps to be carried out over a defined period of time to achieve the client's goals and objectives.

The invention is broadly performed in three stages with the collection of data from a client, processing the data to provide a meaningful result of objectives and goals, and thirdly as input to developing a financial plan and actioning steps to achieve the goals and objectives of the client.

In the present example, a client logs onto a website hosted on a remote server and accesses a program which sets out questions and processes the input answers to achieve a meaningful result displayed in the form of calculations, matrices and actionable steps. The client is asked to complete a questionnaire. In a first section, the questionnaire sets out a series of questions in different categories comprising “Satisfaction with Life” (Part A), “Core Motivations” (Part B), “Life Domains” (Part C), “Importance of Life Domains To Core Motivations” (Part D). In a second section, the questionnaire continues to explore the life domains that the client identified earlier as being important and why the client believes they contribute most to their life satisfaction. While answers to the questions are chosen from a Liked Type rating scale, there is the opportunity for the client to add their own initiatives in exploring their important life domains in the second section of the questionnaire. An example of a questionnaire is provided in FIG. 1.

With respect to Satisfaction with Life (Part A), five questions are asked and the client selects one level for each question based on a rating scale where 1 is terrible and 7 is delighted. The client enters their answers directly on the displayed web page. From the culmination of the answers to each of the questions, a score (in percentage terms) of the client's satisfaction with life is calculated. The answer to each question is weighted differently and a greater weight is given to those questions that have been statistically determined to be more important with respect to evaluating life satisfaction. The calculation of the client's life satisfaction is determined from processing the answers using the encoded programming hosted on the remote server.

With respect to Core Motivations (Part B), the client indicates the importance of each of six motivations (or aspirations) using a scale of 1 to 5 where 1 is not important and 5 is very important. The client also orders the six motivations from the most important to the least important.

The importance and satisfaction associated with the life domains comprising home, personal finances, work, personal growth, family life, social life, recreation and health are answered by the client using a scale of 1 (not important) to 5 (very important) in Life Domains (Part C).

The client then selects which of the life domains contribute to the client's core motivations or aspirations in Part D of the questionnaire.

The answers to the questions in Part C are statistically analyzed and processed by the program on the remote server to provide a progress score for each life domain. The progress score for each life domain is a percentage value determined by the level of satisfaction associated with the life domain relative to its importance.

With each of the identified important Life Domains, the client then selects or identifies important activities that will progress or satisfy the Life Domain and associates a time frame with the identified activity. The program can then process the information to provide a series of related matrices or a cumulative matrix.

The client initially identifies mid-level domains of “What they are seeking to achieve” and linking the “Why” or motivational goal that guides the behaviour. The resultant linkages provide a first linkage map or a first matrix. The client then uses their selected domains to link their ‘What’ domains with the ‘How’ activities to provide a second linkage map or second matrix. The client only selects the domains that are important to them. The client can also add activities to suit their requirements.

Each matrix is formed with respect to importance (on a scale of 1 to 5 where 1 is not important and 5 is the most important) and time frame (with a scale where 1 is continuous, 2 is within 1 year, 3 is within 2-5 years, 4 is within 5-10 years and 5 is more than 10 years).

The matrices may be formed with respect to other parameters.

Each matrix defined by different parameters is then combined to form a cumulative matrix (see FIG. 2) where the values are calculated to give an overall map for matrix one and matrix two. Statistical analysis is also periodically performed to match against population norms.

FIG. 2 shows a cumulative matrix from a hypothetical client. The client has a life satisfaction score of 61% signifying that they are prepared to consider changes to their current lifestyle. Life satisfaction is linked to a client's core motivations. Looking to their priority, ‘Secure Lifestyle’ is the primary and driving motivation for the client. The life domains of ‘Home’, ‘Personal Finance’, ‘Work’, ‘Family Life’, and ‘Health’ are seen to support a ‘Secure Lifestyle’. To improve the client's life satisfaction score and move them toward a ‘Secure Lifestyle’, an adviser would highlight to the client the progress scores for the supporting life domains. FIG. 2 identifies that ‘Personal Finances’ has been rated the lowest progress with a score of 40% signifying that the client is quite dissatisfied with their achievement in this Life Domain. A focus on the subordinate activities will be a priority to increase the client's level of satisfaction and hence move them toward their driving motivation of ‘Secure Lifestyle’. The adviser would then examine, in turn, the other supporting domains of ‘Health’ (progress score of 60%), ‘Work’ (75%), ‘Home’ (80%), and ‘Family Life’ (80%).

In examining the above-mentioned Life Domains, it is relevant to also identify the second and third priority motivations; ‘Quality Relationships’ and ‘Sense of Accomplishment’. The Life Domains supporting the first priority ‘Secure Lifestyle’ may also support these lower priority motivations, providing additional payoff for the client from investing time and resources in the relevant subordinate activities.

Also a focus on ‘Work’ and ‘Family Life’ domains would help achieve progress in the motivations of ‘Quality Relationships’(second priority motivation) and ‘Sense of Accomplishment’ (third priority motivation). The latter motivator is also supported by ‘Personal Finance’, ‘Home’ and ‘Personal Growth’. It is at this level of detail that the adviser can specify a client's financial objectives.

After identifying the relevant Life Domains on which to focus, the client and (their adviser) can examine the timing of the identified activities (and any sub-activities) and work towards achieving these activities.

Ancillary to the encoding of client responses to the matrices, the client was also asked to answer questions based on the following measures:

1. Selected demographic variables (age, gender, marital status, family income)

2. Cognitive age

A further option is for the adviser to engage the client. During this meeting the client will select and discuss the major goals and objectives that they want to pursue.

Working from the matrix map(s), the adviser will discuss with the client the priority of motivations they are seeking to achieve, and then highlight the life domains which support the priority motivation. The adviser will discuss with the client the progress score for each domain. This score highlights the extent to which the client believes they have achieved a satisfactory outcome in the respective life domain relative to the importance they place on that domain. Where this score is below 100%, the adviser can work with the client to select the domains where further progress will increase their life satisfaction score. These domains may also support the second priority motivation so the adviser can highlight how there may be additional payoffs from investing in the subordinate activities that link to the life domains. The subordinate activities are likely to encompass a number of sub-activities and timeframes which can then be drawn out by the adviser through a series of open-ended questions encompassing:

5. “Does the activity you have specified for the domain require you to undertake a number of sub-activities or steps?”

6. “What are the respective timeframes for these sub-activities?”

7. “To what extent will money be important to achieving . . . ?”

8. “How much money do you think will be required to achieve . . . ?”

9. “Who will be responsible for making it happen?”

10. “What skills will be required?”

11. “What resources will be required?”

12. “How much time will it take?”

The answers to these will form the basis on which the adviser will prepare their financial plan.

Preferably this method is repeated on a regular basis to assist the progressive achievement of personally relevant goals and objectives.

The preferred embodiment of the present invention identifies the means-to-an-end in the client's mind, the importance of the activity that underpins achievement of a life domain objective, and the higher-order motivation that may exist for them. Further, the methodology graphically illustrates the interconnectedness between the three levels through developing personal goal maps for each client. Where married couples complete the method, the different goal maps will highlight the importance of creating a financial plan that facilitates mutually agreed goals.

The output provides a much deeper knowledge of the implications of potential short-term decisions on the achievement of longer term goals. Importantly, not all goals will require additional financial means.

While the example of financial planning was provided, the invention can also be applied to corporate business planning where stakeholders provide data and the data is processed to provide a set of objectives and goals for the business. From the identification of common goals and objectives, detailed steps can be planned and actioned to achieve the common goals and objectives. Similarly the invention has application in the insurance industry where it is necessary to provide a person, group or corporation with insurance products that meet their needs and satisfy their objectives. The invention has application in other areas where it is necessary to understand the goals and objectives of a person, couple or group. The invention can be applied within a relatively narrow defined setting such as the objectives relating to a business or a comparatively wider setting such as the objectives associated with a person's life. Furthermore the invention can be applied periodically to the same person, group or corporation as circumstances change and objectives are reached or changed.

### ADVANTAGES

An advantage of the preferred embodiment of the present invention comprises providing a structured and quantitative method for goal setting that will provide clarity and greater meaning than current qualitative analysis. The preferred embodiment of the present invention provides a mechanism by which financial planners can effectively identify client objectives and hence construct a personally relevant financial plan for clients. The preferred method provides a structured way to help financial planner.

In addition the preferred embodiment has other beneficial advantages comprising enabling a person to focus on their lifestyle goals and identify initiatives that will allow the person to achieve these goals.

The method has real and commercial outcomes as future decisions and type of commercial purchases will depend on the results of the method. The method provides a solution to identify and make real and relevant the intangible aspects of life that motivates a person. The method is suitable for use by financial planners, human resource personnel, life coaches and legal mediators.

### VARIATIONS

It will of course be realized that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims this specification the word “comprise” and variations of that word such as “comprises” and “comprising”, are not intended to exclude other additives, components, integers or steps.

1. A computer-implemented method of analyzing a person's goals comprising:
entering data from a terminal computer by the person to a program hosted on a server computer system;
processing said data by the program to identify one or more core motivations relative to their importance , said core motivations comprise secure lifestyle, quality relationships, sense of accomplishment, being well respected, helping others and fun and enjoyment in life; to identify one or more life domains relative to their importance and the person's satisfaction with the life domain, said life domains comprise home, personal finance, work, personal growth, family life, social life, recreation and health; and to statistically analyze the contribution that each life domain provides to each of the relevant core motivations;
processing said data to identify activities that progress each of the relevant life domains; and
producing a relevant advice product from the processed data that sets out one or more actions selected from the activities to be carried out within a timeframe and being relevant to the person's goals wherein the performance of the one or more actions will progress the person's life satisfaction.

2. A computer-implemented method of analyzing a person's goals as claimed in claim 1, wherein the advice product is in the form of a multidimensional representation or map that interrelates the person's priority motivation with a life activity in a prevailing life domain and is used to identify the importance of each life activity to the person.

3. A computer program product having stored thereon computer executable instructions, which when executed, causes the computer to perform the method as claimed in claim 1.

4. A web-based computer program product having stored thereon computer executable instructions, which when executed on a web-based computer system causes the web-based computer system to perform the method as claimed in claim 1.

5. A computer system for notifying a person of relevant actions to be carried out to enhance their level of life satisfaction, the computer system comprising:
a processor, memory interfaced with the processor, and a network interface for establishing a network connection over a data communication network with a terminal computer;
a module for detecting at least one activity occurring at a terminal computer that is activated for displaying or requesting information to elicit data from the person,
a module for processing the data from the person to identify one or more core motivations relative to their importance , said core motivations comprise secure lifestyle, quality relationships, sense of accomplishment, being well respected, helping others and fun and enjoyment in life; to identify one or more life domains relative to their importance and the person's satisfaction with the life domain, said life domains comprise home, personal finance, work, personal growth, family life, social life, recreation and health; and to statistically analyze the contribution that each life domain provides to each of the relevant life domains; and processing said data to identify activities that progress each of the relevant core motivations;
a module to display or provide a relevant advice product comprising one or more actions relevant to progressing the person's life satisfaction.

6. A computer-implemented method to identify a person's financial goals with reference to their life goals and motivations, comprising
entering data from a terminal computer by the person to a program hosted on a server computer system;
processing said data by the program to identify one or more core motivations relative to their importance , said core motivations comprise secure lifestyle, quality relationships, sense of accomplishment, being well respected, helping others and fun and enjoyment in life; to identify one or more life domains relative to their importance and the person's satisfaction with the life domain, said life domains comprise home, personal finance, work, personal growth, family life, social life, recreation and health; and to statistically analyze the contribution that each life domain provides to each of the relevant core motivations;
processing said data to identify activities that progress each of the relevant life domains; and
producing a relevant financial advice product from the processed data that sets out one or more actions selected from the activities to be carried out within a timeframe and being aligned with the person's life goals and motivations, wherein the performance of the one or more actions will contribute to achieving the person's financial goals.

7. A computer-implemented method as claimed in claim 6 comprising the additional step of preparing a financial plan based on the identified one or more actions and determining what tasks are needed, who is responsible for carrying out the tasks, when are the tasks to be carried out and what is needed to carry out the tasks so that the person has a time framed sequence of steps to in order to achieve their financial goals.
